(19) United States
(12) Patent Application Publication
(10) Pub. No.: US 2015/0106653 A1
(43) Pub. Date: Apr. 16, 2015

(54) TEST SELECTION BASED ON DOMINATION CRITERION

(71) Applicant: International Business Machines Corporation, Armonk, NY (US)

(72) Inventors: Yoram S. Adler, Haifa (IL); Dale E. Blue, Poughkeepsie, NY (US); Eitan D. Farchi, Pardes Hana (IL); Orna Raz-Pelleg, Haifa (IL); Aviad Zlotnick, Mitzpeh Netofah (IL)

(73) Assignee: International Business Machines Corporation, Armonk, NY (US)

(21) Appl. No.: 14/050,378

(22) Filed: Oct. 10, 2013

(51) Int. Cl. G06F 11/22

(52) U.S. Cl. CPC G06F 11/2273
USPC 714/27

(57) ABSTRACT

Method, apparatus and product for test selection based on domination criterion. In some embodiments, excluding from a test suite dominated tests, each of which is dominated by a predetermined number of dominating tests, wherein a dominated test is dominated by a dominating test if each target that is covered by the dominated test is also covered by the dominating test. In some embodiments, a reduced test suite is determined by excluding from a test suite each test that covers a dominated set of targets that is N-dominated by the reduced test suite, wherein a dominated set of targets is N-dominated by a set of tests if each target in the dominated set of targets is covered by at least N tests in the set of tests, wherein N is a predetermined number greater than one.

### TECHNICAL FIELD

The present disclosure relates to testing in general, and to test selection, in particular.

### BACKGROUND

Computerized devices control almost every aspect of our life—from writing documents to controlling traffic lights. However, computerized devices are bug-prone, and thus require a testing phase in which the bugs should be discovered. The testing phase is considered one of the most difficult tasks in designing a computerized device. The cost of not discovering a bug may be enormous, as the consequences of the bug may be disastrous. For example, a bug may cause the injury of a person relying on the designated behavior of the computerized device. Additionally, a bug in hardware or firmware may be expensive to fix, as patching it requires call-back of the computerized device. Hence, many developers of computerized devices invest a substantial portion of the development cycle to discover erroneous behaviors of the computerized device.

During the testing phase a System Under Test (SUT) is being tested. The SUT may be, for example, a computer program, a hardware device, a firmware, an embedded device, a component thereof, or the like. Testing may be performed using a test suite that comprises tests. The test suite may be reused to revalidate that the SUT exhibits a desired functionality with respect to the tests of the test suite. For example, the test suite may be reused to check that SUT works properly after a bug is fixed. The test suite may be used to check that the bug is indeed fixed (with respect to a test that previously induced the erroneous behavior). Additionally or alternatively, the test suite may be used to check that no new bugs were introduced (with respect to other tests of the tests suite that should not be affected by the bug fix). Additionally or alternatively, the test suite may be used to perform regression tests on the SUT.

Test selection is a technique for reducing the testing effort by selecting a subset of the existing tests to run, while preserving a level of confidence in the coverage of the selected tests (see Graves, T. L., Harrold, M., Kim, J.-M., Porter, A., Rothermel, G. An empirical study of regression test selection techniques. ACM Trans. Softw. Eng. Methodol., 184-208 (2001)). The most common criterion for test selection is code coverage, i.e., select a subset of the tests that cover the same code as the original set of tests, or cover code that has recently changed. Other possible criteria for test selection are counts of execution, data values, def-use of variables, and execution time.

Traditional test selection associates with every test a collection of targets that the test satisfies, referred to as coverage task. The targets may be, for example, code sections that are covered when the test is executed, functional coverage of the test, or the like. The goal of traditional test selection is to cover all collection of all the targets in the input test suite with a subset of the test suite. Hence, if a test covers two targets, each of which is covered by other tests of the test suite, test selection may select a subset of the test suite that excludes the test.

Unfortunately, test selection may result in an impact on bug finding, and software practitioners tend to be suspicious of any scheme that proposes not to run all the existing tests. Despite that, test selection may be needed as there may be insufficient resources to execute the entire test suite.

### BRIEF SUMMARY

One exemplary embodiment of the disclosed subject matter is a computerized apparatus having a processor, the processor being adapted to perform the steps of: obtaining a test suite comprising a set of tests, wherein each test is associated with a set of targets that are covered by the test when executed; excluding from the test suite dominated tests, each of which is dominated by a predetermined number of dominating tests, wherein a dominated test is dominated by a dominating test if each target that is covered by the dominated test is also covered by the dominating test; and whereby a reduced test suite is determined, wherein the reduced test suite covers each target covered by the test suite, wherein the reduced test comprises a non-dominated test covering a plurality of targets, and wherein two or more tests in the test suite cover together the plurality of targets.

Another exemplary embodiment of the disclosed subject matter is a computerized apparatus having a processor, the processor being adapted to perform the steps of: obtaining a test suite comprising a set of tests, wherein each test is associated with a set of targets that are covered by the test when executed; determined a reduced test suite by excluding from the test suite each test that covers a dominated set of targets that is N-dominated by the reduced test suite, wherein a dominated set of targets is N-dominated by a set of tests if each target in the dominated set of targets is covered by at least N tests in the set of tests, wherein N is a predetermined number greater than one; and whereby the reduced test suite covers each target covered by the test suite, wherein the reduced test comprises a redundant test covering a plurality of targets, and wherein two or more tests in the test suite cover together the plurality of targets.

Yet another exemplary embodiment of the disclosed subject matter is a computer program product comprising a non-transitory computer readable medium retaining program instructions, which instructions when read by a processor, cause the processor to perform a method comprising: obtaining a test suite comprising a set of tests, wherein each test is associated with a set of targets that are covered by the test when executed; excluding from the test suite dominated tests, each of which is dominated by a predetermined number of dominating tests, wherein a dominated test is dominated by a dominating test if each target that is covered by the dominated test is also covered by the dominating test; and whereby a reduced test suite is determined, wherein the reduced test suite covers each target covered by the test suite, wherein the reduced test comprises a non-dominated test covering a plurality of targets, and wherein two or more tests in the test suite cover together the plurality of targets.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows a flowchart diagram of a method, in accordance with some exemplary embodiments of the disclosed subject matter; and

FIG. 3 shows a block diagram of an apparatus, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem is to provide for a test selection that is not aimed at providing a minimal test suite. Another technical problem is to provide for a fine grained test selection in which the user can control a level of reduction to the test suite.

Traditional test selection processes aim at providing a minimal reduced test suite that does not include any redundancy but have the same targets coverage as the original test suite. However, as targets of tests are mere abstraction of the utility of each test, the reduced test suite may have a reduced coverage.

The disclosed subject matter provides for a test selection method that is less strict and which allows the user to control a level of reduction. Allowing the user to tune the test selection process may be useful to address the user's potential concerns regarding removal of existing tests from a test suite. It will be noted that in some cases, the user may not be the designer of all the tests of the test suite as they may be tests that were designed a long time ago, as may be the case with regression test suites. In some cases, the user may not know what was the purpose of designing each such test, and what testing functionality each such test fulfills. Hence, the user may be wary in excluding tests from the test suite simply because each target they cover is covered by two or more other tests in the test suite, as is the case with traditional test selection.

One technical solution is to utilize a domination criterion to perform test selection. One domination criterion may be a test domination criterion.

Test t₁ dominates test t₂ if t₁ covers all targets that are covered by t₂. In such a case, t₁ is said to be a dominating test of the dominated test, t₂. In some exemplary embodiments, the disclosed subject matter may exclude tests that are dominated by N₁ or more tests in the test suite.

It will be noted that a test selection process that is based on test domination criterion is more stringent than traditional test selection processes that allow rejection of tests that are covered even by a combination of selected tests. By increasing the N₁ parameter, the tests selection becomes even more stringent and thus is involved with a reduced risk of substantial adverse effect on the testing process.

Another domination criterion may be a dominated target set criterion.

A set of targets is said to be N₂-dominated by a set of tests, if each target x₁ of the set of targets is covered by at least N₂ tests in the set of tests. In some exemplary embodiments, the N₂ parameter may be any number larger than one, such as 2, 3, 10, or the like.

It will be noted that a test selection process that is based on a dominated target set criterion (with N₂>1) is more stringent than traditional test selection processes in which each target of the excluded test may be covered by a single test in the reduced test suite. By increasing the N₂ parameter, the tests selection becomes even more stringent and thus is involved with a reduced risk of substantial adverse effect on the testing process.

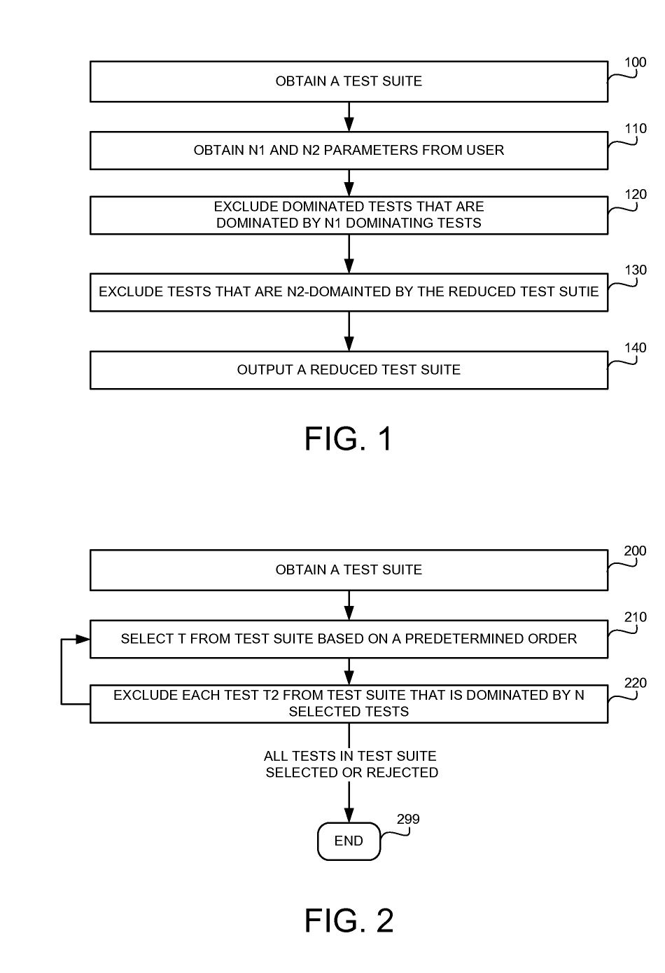

Referring now to FIG. 1 showing a flowchart diagram of a method, in accordance with some exemplary embodiments of the disclosed subject matter.

In Step 100, a test suite is obtained. The test suite may be obtained in an electronic form, such as in computer-readable medium.

In Step 110, the user may provide parameters for the test selection process. The user may provide a N₁ parameter to be used with respect to the test domination criterion. The user may provide a N₂ parameter to be used with respect to the dominated target set criterion. In some exemplary embodiments, there may be default values defined for the N₁ and/or N₂ parameters to be used in the absence of user input. In some exemplary embodiments, the user may select to use only one criterion out of the two domination criteria.

In Step 120, the test domination criterion may be applied to exclude tests from the test suite. In some exemplary embodiments, tests that are dominated by at least N₁ other tests may be excluded from the test suite.

In Step 130, the dominated target set criterion may be applied to exclude tests from the test suite. In some exemplary embodiments, tests which cover a target set test that is N₂-dominated by the other tests may be excluded from the test suite.

In Step 140, after the exclusion of Step 120 and/or Step 130, a reduced test suite is determined The reduced test suite may be outputted. The user may use the test suite, may review the excluded tests thereof and be notified of such a reason, or the like.

It will be noted that as traditional test selection is not used, the reduced test suite may still include tests which may be considered as redundant under traditional test selection scheme. As an example, test t₁ that covers x₁ and x₂ may not be excluded from the test suite based on the above-mentioned criteria even in case that the test suite also includes test t₂ that covers x₁ and test t₃ that covers x₂.

Referring now to FIG. 2 showing a flowchart diagram of a method, in accordance with some exemplary embodiments of the disclosed subject matter. FIG. 2 exemplifies a test selection process that is based on the a test domination criterion.

In Step 200, a test suite is obtained.

In Step 210, a test t is selected from the test suite. The selection may be based on some predetermined order. For example, the order of selection may be dictated by the number of targets that the test satisfies. The selected test may be the test covering most targets out of the (non-selected portion of) the test suite. As another example, the order of selection may be based on the frequency of the targets that are covered by the test. Each test may be assigned a weight that is inversely proportional to the frequency of the targets it satisfies. The order of selection may be based on a highest weight instead of or in addition to the number of covered targets.

In some exemplary embodiments, step 210 may be initially performed N times to ensure that there would be at least N selected tests.

In Step 220, each test t₂∈Test Suite that is dominated by N tests that were selected is identified and excluded from Test Suite.

If there are still tests in Test Suite that were not selected or rejected, Step 210 may be performed again to select another test after which Step 220 may be performed to exclude more tests based on the selection.

Once all tests of the test suite are either selected or rejected, the test selection process is completed (299) with the selected tests being the reduced test suite.

In some exemplary embodiments, traditional test selection may be performed to determine a minimal test suite. Tests that were excluded by the traditional test selection but are not excluded by any domination criterion (e.g., not dominated by N1 tests and/or not its target set is not N₂-dominated by the reduced set of tests) may be added to the minimal test suite to determine the reduced test suite in accordance with the disclosed subject matter.

Referring now to Fig.

In some exemplary embodiments, if the state is not reachable (e.g., path condition is unsatisfiable), the state may be dropped and State 134 may be performed.

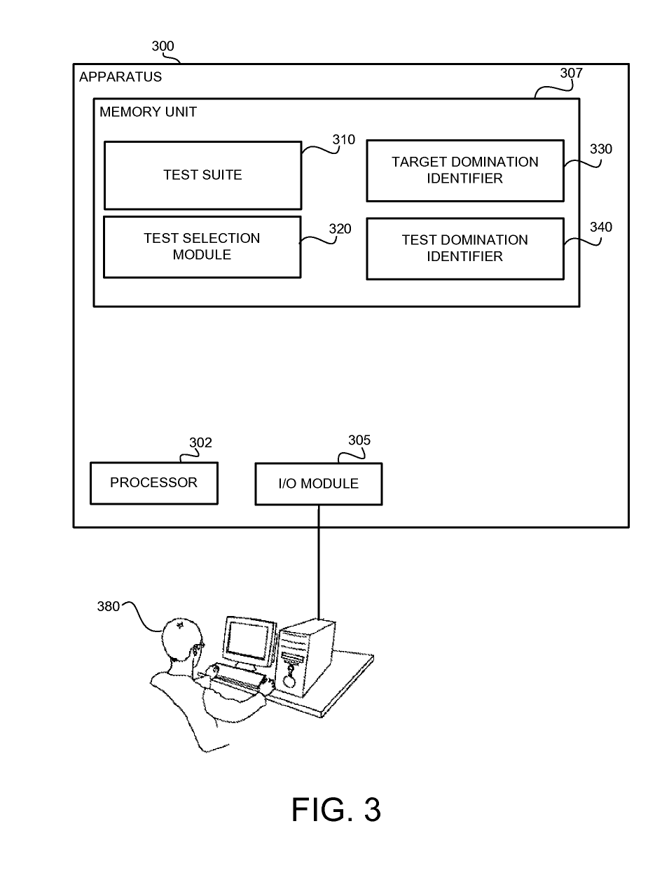

Referring now to FIG. 3 showing a block diagram of components of an apparatus, in accordance with some exemplary embodiments of the disclosed subject matter. An apparatus 300 may be a computerized apparatus adapted to perform methods such as depicted in FIGS. 1A-1B.

In some exemplary embodiments, Apparatus 300 may comprise a Processor 302. Processor 302 may be a Central Processing Unit (CPU), a microprocessor, an electronic circuit, an Integrated Circuit (IC) or the like. Alternatively, Apparatus 300 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). Processor 302 may be utilized to perform computations required by Apparatus 300 or any of it subcomponents.

In some exemplary embodiments of the disclosed subject matter, Apparatus 300 may comprise an Input/Output (I/O) Module 305 such as a terminal, a display, a keyboard, an input device or the like to interact with the system, to invoke the system and to receive results. It will however be appreciated that the system can operate without human operation.

In some exemplary embodiments, the I/O Module 305 may be utilized to provide an interface to a User 380 to interact with Apparatus 300, such as to provide the test suite, to view the reduced test suite, to view excluded tests, to view reasons for excluding a test (e.g., N₁ dominating tests and/or the N₂ tests that dominate the targets of the test), or the like.

In some exemplary embodiments, Apparatus 300 may comprise a Memory Unit 307. Memory Unit 307 may be persistent or volatile. For example, Memory Unit 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 307 may retain program code operative to cause Processor 302 to perform acts associated with any of the steps shown in FIGS. 1A-1B.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A Test Suite 310 may be a representation of a test suite. The Test Suite 310 may be, for example, the tests themselves, a descriptive representation of the tests, or the like. In some exemplary embodiments, the Test Suite 310 may represent each test using a functional representation of its attributes. Additionally or alternatively, each test may be represented by the set of targets that it covers.

A Test Selection Module 320 may be configured to determine a subset of Test

Suite 310 in accordance with the disclosed subject matter. Test Selection Module 320 may be configured to utilize Target Domination Identifier 330 and/or Test Domination Identifier 340 to determine which tests to exclude from Test Suite 310. In some exemplary embodiments, Test Selection Module 320 may be configured to perform a method such as depicted in FIG. 1 and/or FIG. 2.

Target Domination Identifier 330 may be useful in implementing an N-dominated target set criterion. Target Domination Identifier 330 may be configured to identify for a target tests that cover the target. Target Domination Identifier 330 may be useful in determining whether each target of a test is covered by N or more tests in a set of tests (e.g., a reduced test suite). In some exemplary embodiments, Target Domination Identifier 330 may be used to determine whether or not to exclude a test based on the N-dominated target set criterion.

Test Domination Identifier 340 may be useful in implementing a test domination criterion. Test Domination Identifier 340 may be configured to identify for a test each dominating test that dominates the test. Test Domination Identifier 340 may be useful in determining whether a test is dominated by N or more tests. In some exemplary embodiments, Test Domination Identifier 340 may be used to determine whether or not to exclude a test based on the test domination criterion. It will be noted that the test domination criterion may be a parameterized criterion, the parameter of which may be the number N.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computerized apparatus having a processor, the processor being adapted to perform the steps of:
obtaining a test suite comprising a set of tests, wherein each test is associated with a set of targets that are covered by the test when executed;
excluding from the test suite dominated tests, each of which is dominated by a predetermined number of dominating tests, wherein a dominated test is dominated by a dominating test if each target that is covered by the dominated test is also covered by the dominating test; and
whereby a reduced test suite is determined, wherein the reduced test suite covers each target covered by the test suite, wherein the reduced test comprises a non-dominated test covering a plurality of targets, and wherein two or more tests in the test suite cover together the plurality of targets.

2. The apparatus of claim 1, wherein the predetermined number is one.

3. The apparatus of claim 1, wherein the predetermined number is defined by a user.

4. The apparatus of claim 1, wherein the processor further being adapted to perform exclusion of tests from the test suite based on a N-dominated target set criterion, wherein N is a number greater than one.

5. A computerized apparatus having a processor, the processor being adapted to perform the steps of:
obtaining a test suite comprising a set of tests, wherein each test is associated with a set of targets that are covered by the test when executed;
determined a reduced test suite by excluding from the test suite each test that covers a dominated set of targets that is N-dominated by the reduced test suite, wherein a dominated set of targets is N-dominated by a set of tests if each target in the dominated set of targets is covered by at least N tests in the set of tests, wherein N is a predetermined number greater than one; and
whereby the reduced test suite covers each target covered by the test suite, wherein the reduced test comprises a redundant test covering a plurality of targets, and wherein two or more tests in the test suite cover together the plurality of targets.

6. The apparatus of claim 5, wherein N is defined by a user.

7. The apparatus of claim 5, wherein the processor further being adapted to perform exclusion of tests from the test suite based on a test domination criterion.

8. The apparatus of claim 7, wherein the test domination criterion is associated with a parameter, wherein the parameter is a predetermined number indicating a number of dominating tests that dominate a dominated test in order to exclude the dominated test from the test suite according to the test domination criterion.

9. A computer program product comprising a non-transitory computer readable medium retaining program instructions, which instructions when read by a processor, cause the processor to perform a method comprising:
obtaining a test suite comprising a set of tests, wherein each test is associated with a set of targets that are covered by the test when executed;
excluding from the test suite dominated tests, each of which is dominated by a predetermined number of dominating tests, wherein a dominated test is dominated by a dominating test if each target that is covered by the dominated test is also covered by the dominating test; and
whereby a reduced test suite is determined, wherein the reduced test suite covers each target covered by the test suite, wherein the reduced test comprises a non-dominated test covering a plurality of targets, and wherein two or more tests in the test suite cover together the plurality of targets.

10. The computer program product of claim 9, wherein the predetermined number is one.

11. The computer program product of claim 9, wherein the predetermined number is defined by a user.

12. The computer program product of claim 9, wherein the instructions when ready by the processor further cause the processor to perform exclusion of tests from the test suite based on a N-dominated target set criterion, wherein N is a number greater than one.
